(19) United States
(12) Patent Application Publication
(10) Pub. No.: US 2019/0186431 A1
(43) Pub. Date: Jun. 20, 2019

(54) TUBE, IN PARTICULAR A FLAT TUBE FOR AN EXHAUST GAS COOLER AND EXHAUST GAS COOLER

(71) Applicant: Hanon Systems, Daejeon (KR)

(72) Inventors: Ronny Koch, Kerpen (DE); Oliver Fischer, Aachen (DE); Petr Sispera, Ostroh (CZ); Jiri Tomecek, Vnorovy (CZ)

(21) Appl. No.: 16/216,146

(22) Filed: Dec. 11, 2018

(30) Foreign Application Priority Data
Dec. 14, 2017 (DE) 102017222742.7

(51) Int. Cl. F02M 26/29; F28D 7/16; F28D 21/00; F28F 1/04; F28F 1/06; F28F 1/08

(52) U.S. Cl. CPC F02M 26/29; F28D 7/1684; F28F 1/08; F28F 1/04; F28F 1/06; F28D 21/0003

(57) ABSTRACT

A tube (10) for an exhaust gas cooler comprises at least two projections (14), developed on the inside, of which at least one, implemented closer to the gas inlet, is developed lower in the direction toward the tube axis than at least one that is implemented closer to the gas outlet.

An exhaust gas cooler comprises at least one such tube.

### FIELD OF TECHNOLOGY

The invention relates to a tube, in particular a flat tube, for an exhaust gas cooler and an exhaust gas cooler with at least one such tube.

To decrease the emission of harmful substances from internal combustion engines, it is known to recirculate exhaust gas to the fresh air side, wherein, at least under certain operating conditions, the exhaust gas must be cooled. In order to satisfy the continuously stricter requirements with regard to harmful substance emissions, increasingly more efficient exhaust gas coolers are required.

### PRIOR ART

Exhaust gas coolers of prior use are known that comprise numerous flat tubes through which flows the exhaust gas and which include on the inside numerous projections to ensure good heat transfer. However, in particular at the gas inlet, overheating of the coolant that is utilized for cooling the exhaust gas may occur such that air bubble formation may occur in the coolant circulation. Moreover, in the case of such projections it must be noted that they increase the pressure drop and therewith cannot be developed at any desired height or depth, which means they cannot be developed extending far into the tube interior. To overcome said limitations, it is fundamentally conceivable to provide more flat tubes through which the gas must flow which, however, entails the disadvantage of a rise in expenditures and space requirement.

### DESCRIPTION OF THE INVENTION

Against this background the invention addresses the problem of specifying a tube for an exhaust gas cooler that represents an improvement with regard to efficiency.

This problem is resolved through the tube described in patent claim 1.

The tube according to the invention, which will be described in the following with reference to the preferred embodiment of a flat tube, comprises conventionally numerous, yet in every case at least two, projections developed on the inside, of which at least one is implemented closer to the gas inlet, in the direction toward the tube axis at a lower level, than at least one projection implemented closer to the gas outlet. Stated differently, the height/depth of the projections or their extent increases in the direction of the interior of the tube and/or in the direction of flow of the gas, such that at the gas inlet overheating of the coolant can be avoided and the heat transfer can be equalized over the course of the tube. This is achieved in particular thereby that the height/depth of the projections increases in the gas flow direction such that a turbulent flow is also maintained in the direction of the gas outlet and consequently the heat transfer and the pressure loss are optimized over the length of the tube. Especially the pressure loss at the gas inlet as well as the heat transfer are decreased since at this site the gas temperature is highest, however, the gas velocity, due to the comparatively flat projections, remains high. The boiling of the coolant in the proximity of the gas inlet can therewith be decreased and an extensive portion of the heat transfer can be shifted in the direction toward the gas outlet. Hereby the efficiency of an exhaust gas cooler equipped with the described tube is overall increased. With regard to the projections, it should be stated that they may be developed flat and advantageously can appear on the outside of the tube in the form of indentations, impressions, dents, pits or dimples. However, critical is the projection in the direction of the tube interior which ensures the described effects. By ‘flat’ projection is understood that the projection has a surface that extends substantially parallel to the tube axis, in other words parallel to the direction of flow.

Preferred further developments of the flat tube according to the invention are described in the further claims.

As stated, it is preferred for the height/depth of the projection in the direction of the tube axis increases continuously, wherein directly adjacent projections, if need be, are developed of the identical height/depth. The described effects can hereby be especially extensively maintained.

In view of the cross section of the flat tube according to the invention it is preferred for the flat tube to comprise at least two parallel side walls in which preferably the projections, or the indentations on the outside of the tube, are developed. In particular, these are preferably provided in both parallel side walls. The “other” walls can be lower and/or rounded.

Further, elongated projections have been found to be especially efficient. Regarding their orientation, it is preferred for them to extend at an angle to the direction of flow. This is especially preferred for high-pressure heat exchangers; however, in particular in low-pressure heat exchangers elongated projections can also extend substantially perpendicularly to the direction of flow.

To maintain turbulent flow, it is in this connection further preferred for the elongated projections of opposing side walls to criss-cross.

Especially good results in view of efficiency are further anticipated if the projections have a height/depth of 1% to 40%, preferably 10% to 30%, of the distance between two (preferably parallel) side walls, in other words of the height of the tube.

Further, a flow cross section for the flat tube according to the invention has been found successful which, apart from the described projections, is implemented uniform over the length of the tube.

Subject matter of the invention is further an exhaust gas cooler, in particular that of an exhaust gas recirculation system, with at least one tube, preferably numerous tubes, described above.

### BRIEF DESCRIPTION OF THE DRAWING

In the following a preferred embodiment example of the invention is described in greater detail with reference to the Figures. In the drawing depict:

FIG. 1 a perspective view of a flat tube according to the invention;

FIG. 2 a cross sectional view of the flat tube according to FIG. 1;

FIG. 3 a sectional view A-A according to FIG. 2 of the flat tube of FIGS. 1 and 2 in the proximity B of FIG. 1; and

FIG. 4 a sectional view A-A according to FIG. 2 of the flat tube of FIGS. 1 and 2 in the proximity of C of FIG. 1.

### DETAILED DESCRIPTION OF A PREFERRED EMBODIMENT OF THE INVENTION

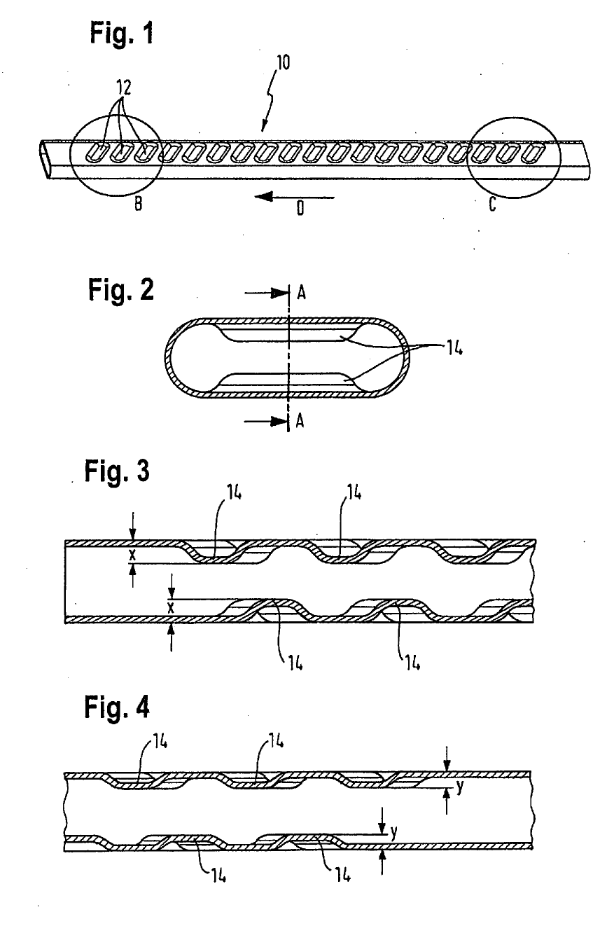

As shown in FIG. 1, the linear flat tube 10 according to the invention has a constant wall thickness over its length and, on its outerside, comprises numerous elongated indentations 12 that extend at an angle, for example of 40 to 50°, to the tube axis. Each of the indentations 12 has a substantially strip-shaped “bottom” toward which all transitions from the outer tube surface are radiused.

As is especially clearly shown in FIG. 2, these indentations developed on the tube outerside form on the innerside numerous projections 14, that have a certain height/depth, wherein said bottom of each indentation forms on the tube innerside a surficial face of the projection, which extends substantially parallel to the tube axis. In the direction of the tube axis the projections have substantially a width that corresponds substantially to the distance between two projections. The projection seen in FIG. 2 of the projections 14 in the direction of the tube axis corresponds substantially to the width seen in FIG. 2 of flat tube 10 without the rounded side sections. Projections 14 are developed obliquely toward the tube axis or, viewed on the inside, minimally concavely. Over their predominant width seen in FIG. 2 their respective “bottoms” are parallel with respect to one another and to the upper and lower delimitation of the flat tube 10.

In FIG. 3 can be seen especially clearly each of the radiused transitions from the tube outside to the projection and “back to the tube outerside”. It further is evident in FIG. 3 that the projections of opposing tube walls are developed such that they criss-cross as viewed from above or below and do not oppose each other exactly but are minimally offset with respect to one another in the direction of the tube axis.

Based on the comparison of FIGS. 3 and 4, it can be seen that the height/depth of the projections increases in the direction toward the tube outlet. According to the flow direction D of the gas in FIG. 1, in FIG. 3 the region B of the tube outlet is shown in which the projections have a height/depth X of approximately 30% of that in FIGS. 3 and 4 evident from top to bottom of the height of the tube. In the proximity of tube inlet C shown in FIG. 4, this height/depth Y is 10 to 20% of the height of the tube. Stated differently, X is according to the invention greater than Y. The upper and lower tube wall evident in FIGS. 3 and 4 is on the sides, not evident in FIGS. 3 and 4, that is on the cut-away side directed toward the viewer, and on the side directed away from the viewer connected by substantially semi-cylindrical sections (cf. in this connection FIG. 2).

1.-9. (canceled)

10. A tube for an exhaust gas cooler comprising:
at least two projections on an inside thereof, wherein one of the projections is implemented closer to a gas inlet in the direction toward the gas inlet, is developed lower in the direction of a tube axis than at least one implemented closer to a gas outlet, wherein the tube is flat.

11. A tube according to claim 10, wherein the projection in the direction toward the tube axis become continuously higher/deeper, wherein directly adjacent projections are, as needed, developed of identical height/depth.

12. A tube according to claim 10, wherein this tube comprises in cross section two parallel side walls on each of which projections are developed.

13. A tube according to claim 10, wherein the projections are developed such that they are elongated.

14. A tube according to claim 10, wherein the projections extend at an angle to the direction of flow.

15. A tube according to claim 12, wherein the projections developed on opposing sides criss-cross.

16. A tube according to claim 10, wherein the projections have a height/depth of 1 to 40%, preferably 10 to 30%, of the height of the tube.

17. A tube according to claim 10, wherein, apart from the projections, the tube has a constant flow cross section.

18. A tube according to claim 11, wherein this tube comprises in cross section two parallel side walls on each of which projections are developed.

19. A tube according to claim 11, wherein the projections are developed such that they are elongated.

20. A tube according to claim 12, wherein the projections are developed such that they are elongated.

21. A tube according to claim 11, wherein the projections extend at an angle to the direction of flow.

22. A tube according to claim 12, wherein the projections extend at an angle to the direction of flow.

23. A tube according to claim 13, wherein the projections extend at an angle to the direction of flow.

24. A tube according to claim 13, wherein the projections developed on opposing sides criss-cross.

25. A tube according to claim 14, wherein the projections developed on opposing sides criss-cross.

26. A tube according to claim 11, wherein the projections have a height/depth of 1 to 40%, preferably 10 to 30%, of the height of the tube.

27. A tube according to claim 12, wherein the projections have a height/depth of 1 to 40%, preferably 10 to 30%, of the height of the tube.

28. A tube according to claim 13, wherein the projections have a height/depth of 1 to 40%, preferably 10 to 30%, of the height of the tube.

29. Exhaust gas cooler comprising at least one tube according to claim 10.
